(19) United States
(12) Patent Application Publication
(10) Pub. No.: US 2012/0110343 A1
(43) Pub. Date: May 3, 2012

(54) Trustworthy timestamps on data storage devices

(76) Inventors: Zvonimir Z. Bandic, San Jose, CA (US); Cyril Guyot, San Jose, CA (US); Timothy Kohchih Tsai, Alviso, CA (US)

(21) Appl. No.: 12/925,807

(22) Filed: Oct. 29, 2010

(51) Int. Cl. G06F 12/14

(52) U.S. Cl. 713/189

(57) ABSTRACT

Secure timestamps created by a data storage device are described. Metadata timestamp is created for each recorded unit of data (such as a sector) The HDD performs the time-stamping in a secure manner. The timestamp is made secure by performing a secure operation (i.e. one that can only be performed by the HDD) using the data and timestamp. The secure operation uses a secure key that is built-in to the storage device and is not readable outside of the device. In some embodiments the secure operation is encryption using the secure key. In other embodiments the secure operation is a hash code function (such as a Hash-based Message Authentication Code (HMAC) function) that uses the secure key to generate a hash code using at least the recorded data and the timestamp as input. The hash code is then included in the metadata that is recorded for the data unit.

### FIELD OF THE INVENTION

The invention relates to the field of authentication of timestamps that record creation or modification times for computerized data and to methods for designing and operating data storage devices such as hard disk drives.

### BACKGROUND

Prior art data storage devices such as disk drives have drive control systems including means for accepting commands from a host computer including commands related to self-testing, calibration and power management. Each drive has programming code (microcode) in nonvolatile memory for execution by a special purpose processor to enable it to perform essential functions. Various standard communication interfaces with both hardware components and command protocols are commonly used such as IDE, SCSI, Serial ATA, and Fibre Channel Arbitrated Loop (FC-AL).

For legal or financial accounting purposes, a document may need to be notarized or otherwise certified as authentic. Aspects of the document that may be certified include the author, submission time, contents, etc. Current certification architectures include: certification via a human agent, certification via third-party controlled systems (either onsite or offsite). One aspect of certification is trusted time-stamping of documents, which is the process of tracking the creation and modification times for the document in a secure manner.

Implementation of trusted time-stamping requires setting up publicly available tools to manage the timestamps including providing an evidentiary trail of authenticity that can be used in legal proceedings. One existing standard for time-stamping is ANSI/X9 X9.95. Although the timestamps may be recorded on hard drives, the essential parts of the process are performed outside the hard drive (e.g., over networks or by host-software).

Information stored on hard drives can be encrypted using various techniques including bulk encryption in which the drive has built-in encryption capability. Hard drives on the market today provide data encryption for user data, where the encryption key is kept inside the hard drive and drive data is accessible with a user password.

Published US pat application 20090083504 by Belluomini, et al. (Mar. 26, 2009), describes data integrity checking for RAID system. Belluomini describes two types of metadata: atomicity metadata (AMD) and validity metadata (VMD). VMD is said to provide information such as sequence numbers associated with the target data to determine if the data written was corrupted, and AMD provides information on whether the target data and the corresponding VMD were successfully written during an update phase. The AMD may include some type of checksum for the data, which can be an LRC, or a CRC or a hash value. Belluomini's validity metadata (VMD) can be a type of “timestamp” or phase marker, which can be clock-based or associated with a sequence number. The timestamp or phase maker may be changed each time new data is written to the disk and can be kept for each data sector.

### SUMMARY OF THE INVENTION

Embodiments of the invention provide certification of the timestamps for creation or modification of recorded data through the use of a data storage device designed to securely provide this service. The embodiments described below are hard disk drives (HDDs), but the invention can be implemented in devices that are similar to HDDs such as flash drives. Certification of timestamps via HDD provides advantages of lower cost (both initial capital outlay and ongoing service), as well as potentially simpler chain of trust that is shorter and involves more well-known authorities. An additional advantage is that HDD timestamps according to the invention have no vulnerability to network-centric attacks.

Embodiments of the invention create metadata for each recorded unit of data (such as a sector) that includes at least a timestamp which represents the time that the write operation was performed. The HDD itself performs the time-stamping in a secure manner. The timestamp is made secure by performing a secure operation (i.e. one that can only be performed by the HDD) using the data and timestamp. The secure operation uses a secure key that is built-in to the storage device and is not readable outside of the device. In some embodiments the secure operation is encryption using the secure key. In other embodiments the secure operation is a hash code function (such as a Hash-based Message Authentication Code (HMAC) function) that uses the secure key to generate a hash code using at least the recorded data and the timestamp as input. The hash code is then included in the metadata that is recorded for the data unit.

In each of the embodiments the timestamps are protected from undetected alteration and, therefore, can be authenticated on a unit-by-unit basis by the device by re-computing the secure function upon request. The authentication information provides an evidentiary trail that data read from drive is the unmodified data as recorded of a specific time specified by the timestamp.

### BRIEF DESCRIPTION OF THE FIGURES

FIG. 1 is an illustration of selected components of a disk drive embodiment of the invention using a hash code.

FIG. 2 is an illustration of selected components of a disk drive embodiment of the invention using an encryption function hash code.

FIG. 3 is an illustration of selected components of a disk drive according to an embodiment of the invention using a hash function.

FIG. 4 is an illustration of selected components of a disk drive according to an embodiment of the invention using an encryption function.

### DETAILED DESCRIPTION OF THE INVENTION

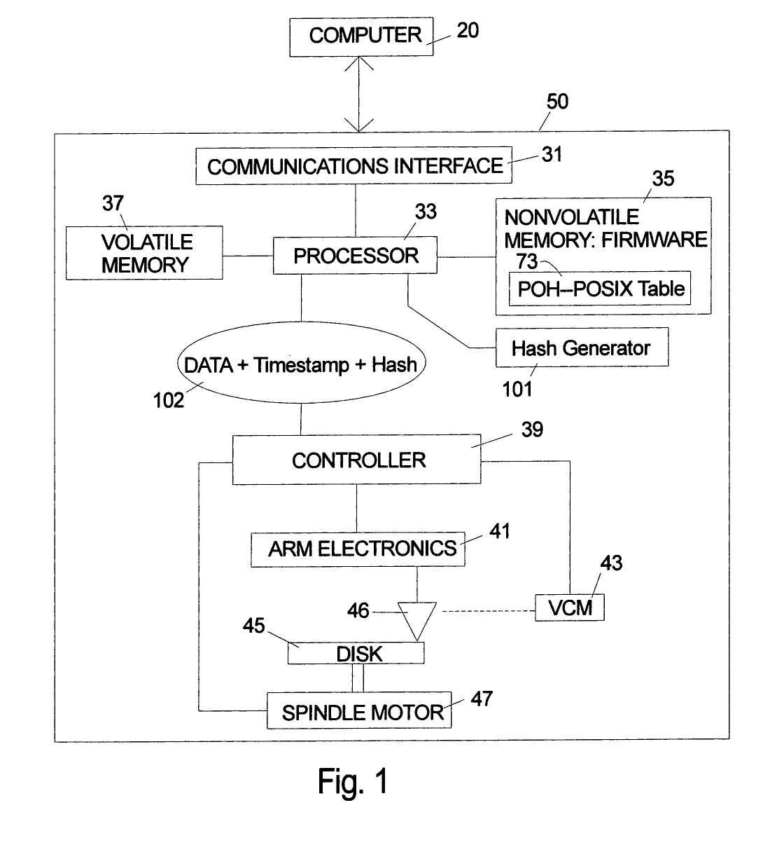

FIG. 1 is a symbolic illustration of a disk drive 50 according to an embodiment of the invention. Information, commands, data, etc. flow back and forth between the host computer 20 and the disk drive 50 through communications interface 31 which can be any hardware interface including any of the prior art interfaces currently in use. The disk drive includes a general purpose microprocessor 33 which accesses both volatile memory 37 and nonvolatile memory 35. The program code (firmware) for the microprocessor 33 can be executed in either the volatile memory 37 or nonvolatile memory 35. The program code (firmware) originates in the nonvolatile memory 35 in the form of a preprogrammed device such as an EEprom. The disk drive 50 is shown as including a separate controller 39, but in an alternative embodiment the microprocessor can be designed to handle some or all of the tasks normally performed by a controller. The arm electronics 41, voice coil motor (VCM) 43, disk 45, spindle motor 47 and head 46 are according to the prior art. The disk 45 is coated with thin film media (not shown) in which information is stored. The units of recorded data 102 according to an embodiment of the invention include data, a POSIX timestamp and a hash code. The hash code is generated by Hash Generator 101 and will be further discussed below. The unit of recorded data are stored on and retrieved from the disk 45. The POH-to-POSIX Table 73, which will be further discussed below, is stored in nonvolatile memory 35. The POH-to-POSIX Table 73 is used to map the device's power-on hours (POH) to the POSIX time POSIX time which is elapsed seconds since Jan. 1, 1970, 00:00:00 UTC.

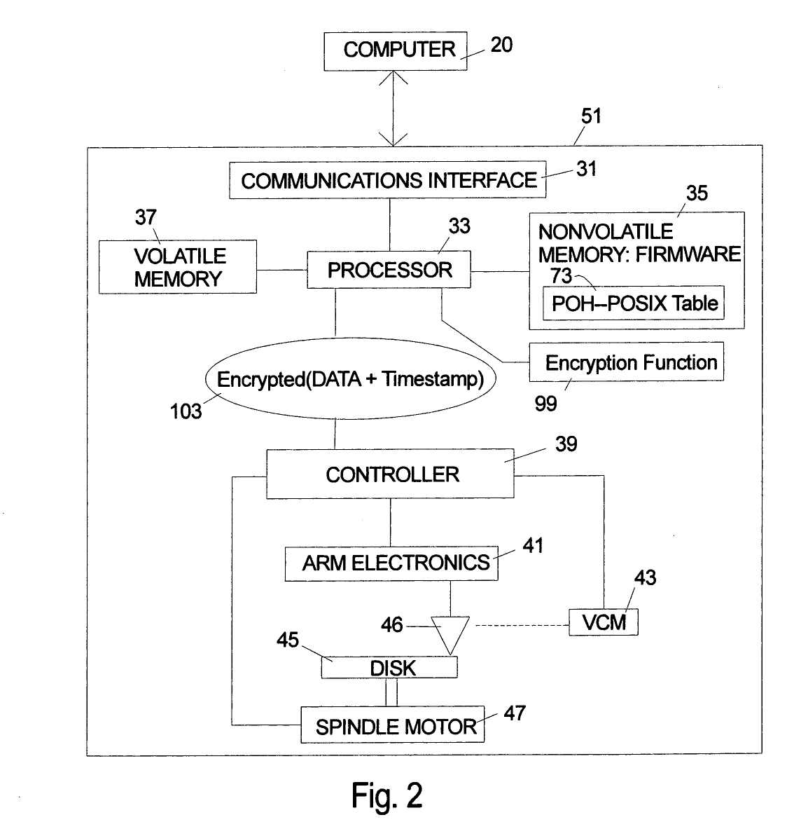

FIG. 2 illustrates an embodiment of the invention in disk drive 51 which uses Encryption Function 99 to encrypt the data and timestamp 102.

The communications interfaces (IDE, SCSI, Serial ATA, Fibre Channel Arbitrated Loop (FC-AL), etc.) used between host computers and disk drives define a format through which the host can give commands and data to the disk drive. The invention can be implemented within the general framework of any of these systems with limited modifications for new commands which will be described below. One modification according to the invention provides a method for the computer to send a request (command) for the authentication information for a unit of data, for example, one or more sectors.

In an embodiment of the invention authentication information should include evidence that data content has not been altered after the data modification timestamp. A request for authentication information (verification) can be sent by a host computer via a new defined command that will be executed by the hard drive according to the invention. The hard drive's communication interface and firmware can be modified to execute the new command. The results for a verification request can be sent back to host through the interface.

In some embodiments the additional metadata for each unit of data written by the drive includes an unencrypted timestamp and a separate cryptographically secured/encoded hash of current-time and data identifier. The data identifier should uniquely identify the data, but the identifier can be a virtual address such as Logical Block Address (LBA) or an actual physical address that is determined by the HDD architecture. Only the HDD knows the secure key, so only the HDD can make hash or verify that the data unit and metadata are unmodified. The secure key is generated by prior art methods such as used for generating the keys for bulk encryption.

Illustrative examples of application for the invention include desktop computers, surveillance systems and central notarized document servers. The authentication data provided is intended to be evidence useful in a court of law or to an auditor that a document, picture, or multimedia file was created/saved at a particular time.

Another use could be to prove that a log as contained in a file had not been altered. The prior art file system nominally maintains the last modified time for the entire file, but such timestamps can be altered and therefore, are not secure. According to the invention trustworthy timestamps cannot be tampered with and increase the granularity of the timestamp to each atomic unit of data, for example a sector. Thus, for example, an append-only log should have monotonically increasing sector timestamps where the timestamp is consistent with the latest application-level time recorded in the log and the latest file system modification time.

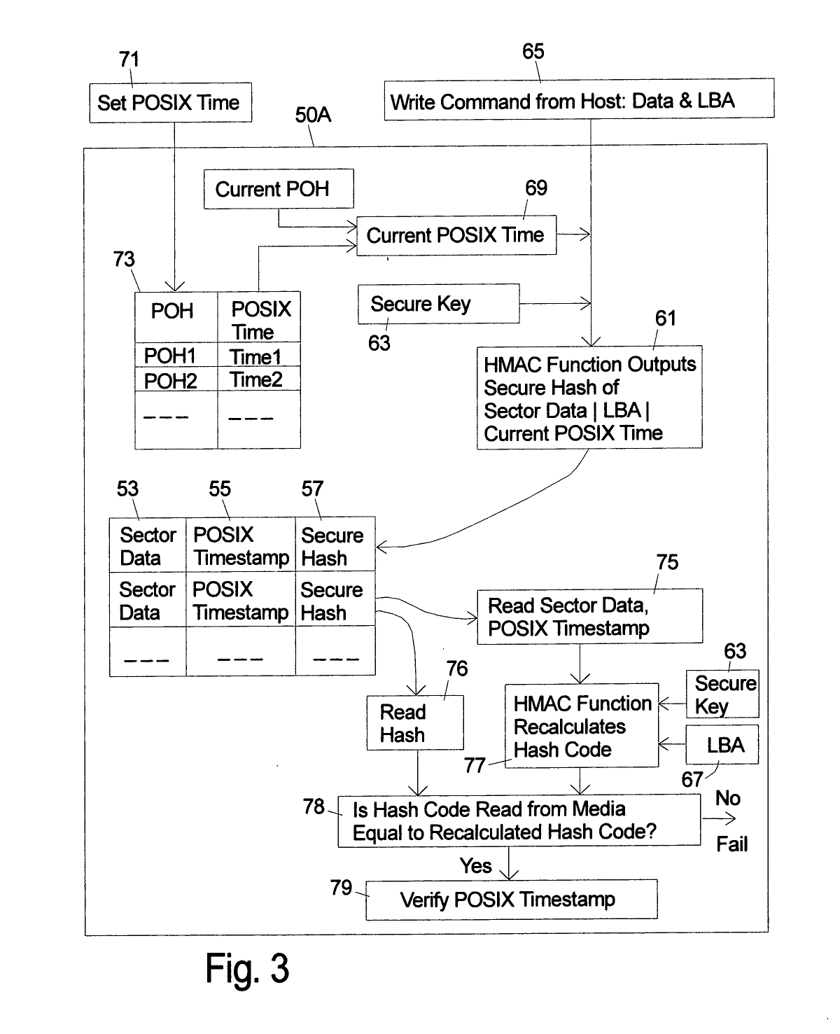

FIG. 3 is an illustration selected components of a disk drive 50A according to an embodiment of the invention using a hash function. The disk drive 50A writes each sector of data 53 on the disk (media) along with the additional metadata that includes a POSIX timestamp 55 and secure hash code 57. In this embodiment the additional metadata is automatically written for every write operation performed by the drive. The number of bits in the POSIX timestamp 55 must be sufficiently large to represent the maximum time value, for example, it can conveniently be either 32 or 64 bits.

Prior art cryptography includes a Hash-based Message Authentication Code (HMAC) function which calculates a message authentication code (MAC) using a cryptographic hash function in combination with a secure (secret) key. A MAC can be used to verify both the data integrity and the authenticity of a message. Any cryptographic hash function can be used in the calculation of an HMAC. HMAC is used in this embodiment to make the timestamp trustworthy and not alterable via any mechanism other than a write operation by the HDD. The disk drive 50 uses an HMAC function 61 with inputs of the secure key 63 and a “message” which is the concatenation of the sector data and the sector LBA (which are specified in a write command 65 from the host computer), and the current POSIX time 69. The output of HMAC function 61 is a secure hash 57 which is written to the media as part of the metadata for the sector. The sector data and the metadata can be written in one write operation, but it is also possible to separately store the metadata. Note that the LBA is not part of the data that is written to the media, but it refers to the address used by the drive the sector. Thus, moving the sector to any other LBA will result in the hash code no longer being valid. However, the LBA is a virtual address assigned by the drive to a physical cylinder/head/sector location. It is advantageous to use the LBA rather than the physical cylinder/head/sector location because the drive might need to relocate the block if the block is determined to be bad as part of the drive's normally functioning. Thus, the drive can move the data as long as the LBA remains the same, but an attacker cannot move the data.

The verification operation is illustrated in the lower right portion of FIG. 3. The verification process is initiated by receiving a command from the host which specifies the LBA. The verification needs to be performed in response to a special command that returns the verified timestamp. Usually the user will want to know the actual timestamp as well as that no tampering has occurred. The user may want to receive the timestamp directly from the drive. The host's file system may also need to compare its current timestamp (which is separately maintained and not secure) against the trusted timestamp from the drive. The typical host's file system only maintains timestamps on a per file basis, but the drive's trusted timestamps are maintained for each sector. A file will typically contain many sectors of data and these sectors may not even be contiguously located on the media. Thus, a file system using the trusted timestamps for sectors will typically need to consolidate multiple timestamps into a single timestamp which will reflect the most recent change.

After receiving a verification command from a host, the sector data and POSIX Timestamp are read 75 and passed as input to HMAC function 77. The LBA 67 and Secure Key 63 are also used as input for the HMAC 77. The secure hash is read from the media 76 but not passed to the HMAC 77. The reconstructed hash code is then compared 78 with the hash code read from the media. If the two are equal, then the drive reports that the POSIX Timestamp for the sector has been verified 79, otherwise the verification fails.

Depending on underlying hash function used in the HMAC, the extra bytes for secure hash 57 will vary. For example, the standard cryptographic hash function known as SHA-1 will result in 20 extra bytes per sector and SHA-512 hash function will yield 64 bytes per sector. The metadata should be covered by the standard error detection and error correction mechanisms used for the sector data. However, the architecture of the drive can be designed to allow the metadata for the sector can be stored separately from the sector data so long as there is the association between the data and metadata is unambiguous and secure.

Because a typical HDD device has no independent method of determining the current time, it must rely on the host to communicate the current POSIX time 71 to the HDD. The secure key 63 and POH to POSIX time table 73 must be stored in nonvolatile memory. There must be at least one entry in the time table 73. The POH and POSIX entries are monotonically increasing. As an example of the conversion process, let T_{POH} be a particular POH timestamp and T_{POSIX} be the corresponding POSIX time. The T_{POSIX} is obtained first by finding POHₓ in the table where POHₓ is less than or equal to T_{POH}. If POHₓ is not the last table entry, then T_{POH} is less than POHₓ₊₁. If POHₓ is the last table entry, then POHₓ₊₁ does not exist. Next T_{POSIX} is found as:

T_{POSIX}=Timeₓ+(T_{POH}−POHₓ)/C
where Timeₓ is the previously calculated POSIX entry corresponding to POHₓ and C is a constant fixed by the firmware for a particular drive and is needed for other normal drive functions.

The key 63 and table 73 should be protected from being altered but must at least be tamper-evident. The key 63 should not be externally readable. The timestamps can be only be verified by the HDD device that created the secure hash code because only the device knows the secure key which is required for verification.

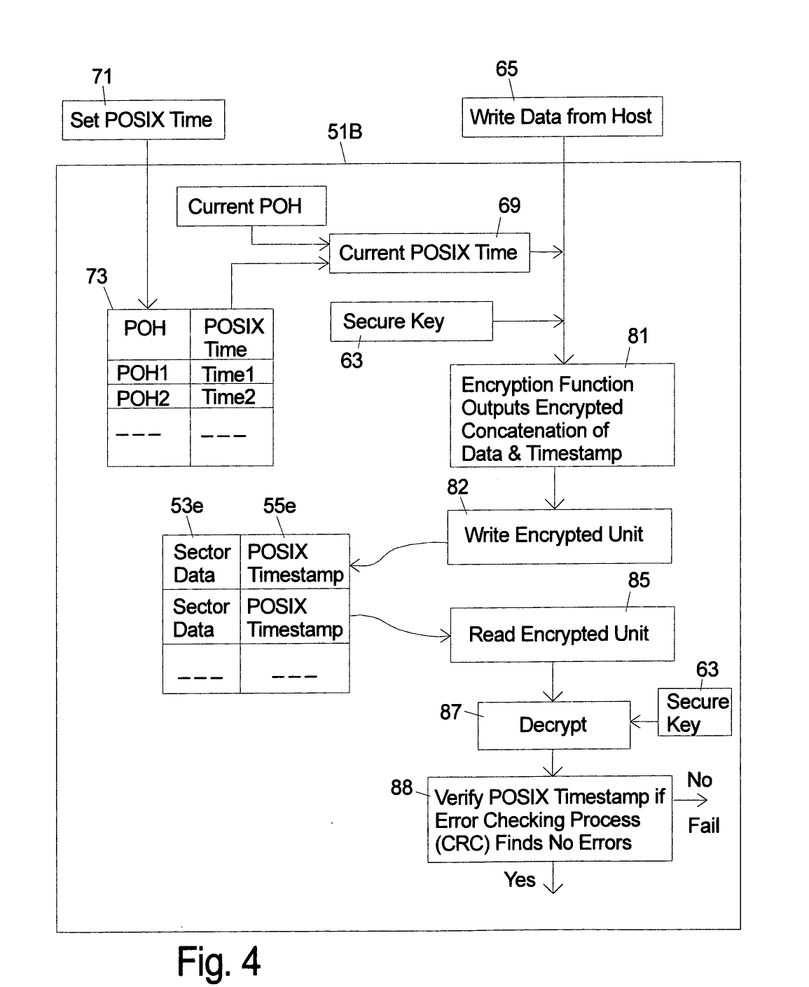

In drives that have a bulk encryption capability, an alternative embodiment of disk drive 51B that uses the built-in encryption function as shown in FIG. 4. In this embodiment the HMAC function is replaced by the encryption/decryption functions. A sector of data to be written to the media is concatenated with the current POSIX timestamp 69 and this combined unit is processed by the encryption function 81 using the secure key 63. The encrypted unit, which includes encrypted sector data 53e and encrypted POSIX timestamp 55e, is then written to the media 82.

The verification process, which is initiated by receiving a command from the host which specifies the address (LBA), reads encrypted unit 85 which is then decrypted using the secure key 63. The verification of the POSIX timestamp 88 consists of achieving an error free read. The standard error checking methods such as a CRC will confirm that the data and the POSIX timestamp have not been altered.

Alternative embodiments of the invention can use shingled writing. In shingled writing a band of adjacent tracks overlap one another and must be written in a specific order. After the overlapping track set has been written, a single track cannot be updated in place without destroying the overlapping tracks. Shingled writing, therefore, provides additional security advantages in chronological logs or archives that once written are never updated. This embodiment might be particularly useful for a certified notary for a repository of documents with trustworthy timestamps according to the invention. Both the data (documents) and the timestamps can be shingle-written in this embodiment.

In another alternative embodiment, media space is saved by grouping sectors together such that a single timestamp reflects the last modified time of the sector that was most recently modified.

The invention can be implemented in RAID storage systems that divide data among a set of sectors on multiple disk drives. When using trustworthy timestamps in a RAID configuration, timestamps are written for all sectors on all drives in the system. However, for timestamp verification, the RAID controller according to the invention needs to know which HDD and sector contains the “real” data (i.e., not parity bits) and only requests verification of the timestamp for that real data. Thus sectors in the set containing only parity data can be omitted from the verification operation.

It is worthwhile to consider how a system according to the invention would stand up under various foreseeable attackers seek to alter the timestamps. For example, even if a disk were temporarily removed and replaced in a non-secure device, the timestamp could, of course be destroyed or corrupted, but without knowledge of the secure key no valid timestamps could be created. Timestamps that had been altered would easily detected when the disk was replaced in the original device.

Another type of attack could involve tricking the HDD into using a false current time by, for example, communicating a fraudulent (prior) POSIX time to the HDD. Defending against this possibility requires that the drive place restrictions on setting the time clock. The POSIX time on prior art HDDs cannot be set before the end of the latest time period because HDD power-on-hours (POH)-to-POSIX time table does not allow overlapping time periods. So, even without additional security measures, a setting a sector timestamp to an arbitrary prior time is usually difficult to do unless the HDD was powered off and never powered back on before the desired artificial time.

Another form of attack could be copying the contents (entire contents or at least the significant parts) to a new target HDD that has never been used in the past. The POSIX time on the target HDD could be strategically set to create the desired POH-to-POSIX time table and the desired fraudulent timestamps for each sector. The protection against this attack is the setting of an original entry in the POH-to-POSIX time table recording the time of manufacture of the HDD. The HDD then rejects any POSIX time from a host that is earlier than this manufacturing time, which, therefore, presents a barrier for the earliest fraudulent time that can be set on that HDD.

Making the secure key undiscoverable is important in implementing the invention; therefore, preferably the key is integrated onto an ASIC that also handles much greater functionality, i.e. the key is buried inside a complex integrated circuit. This will hamper attempts to discover the secure key via differential power analysis or physical disassembly. If the packaging is destroyed or otherwise evidently tampered with, the drive will either be unable to verify timestamps or can be determined to be untrustworthy due to tampering. Nondestructive analysis would be very difficult because all processing involved.

The invention has been described with respect to particular embodiments, but modifications, other uses and applications for the techniques according to the invention will be apparent to those skilled in the art.

1. A data storage device comprising:
a nonvolatile memory in which a secure key is pre-recorded, the secure key being unreadable outside of the data storage device;
means for performing a write operation in response to receiving a write command from a host device, the write command specifying data and an address;
means for generating a timestamp for the write operation;
a hash code generator for generating a hash code using the secure key and using at least the data and timestamp as input; and
means for recording the timestamp and hash code as metadata associated with the data.

2. The data storage device of claim 1 wherein the hash code generator also uses the address in generating the hash code.

3. The data storage device of claim 1 further comprising:
means for performing a verification operation in response to receiving a verification command from a host device, the verification command specifying an address; the verification operation including reading the data, timestamp and hash code; calculating a new hash code for the data, timestamp and reporting successful verification if the new hash code equals the hash code read from storage.

4. The data storage device of claim 1 wherein the timestamp is a POSIX timestamp and the data storage device further comprises:
a power-on hours (POH) to POSIX time table containing an original entry recording a time of manufacture of the device; and
means for rejecting any POSIX time from a host that is earlier than the time of manufacture of the device.

5. A method of operation a data storage device comprising:
recording secure key in a nonvolatile memory location in the data storage device, the location being inaccessible to being read outside of the data storage device; and
performing a write operation in response to receiving a write command from a host device, the write command specifying data and an address, the write operation including:
generating a timestamp for the write operation;
generating a hash code using the secure key and using at least the data and timestamp as input; and
recording the timestamp and hash code as metadata associated with the data.

6. The method of claim 5 wherein generating the hash code further comprises using the address in generating the hash code.

7. The method of claim 5 further comprising:
performing a verification operation in response to receiving a verification command from the host device, the verification command specifying an address;
the verification operation including reading the data, timestamp and hash code from storage; calculating a new hash code for the data, timestamp and reporting successful verification if the new hash code equals the hash code read from storage.

8. The method of claim 5 wherein the timestamp is a POSIX timestamp and generating the timestamp for the write operation further comprises using a table that maps power-on hours to a POSIX time.

9. The method of claim 8 wherein the table contains an entry recording a time of manufacture of the device that is used as an earliest allowed POSIX time.

10. A data storage device comprising:
a nonvolatile memory in which a secure key is pre-recorded, the secure key being unreadable outside of the data storage device;
means for performing a write operation in response to receiving a write command from a host device, the write command specifying data and an address;
means for generating a timestamp for the write operation;
an encryption function for encrypting the data and timestamp using the secure key producing an encrypted record; and
means for recording the encrypted record at the address.

11. The data storage device of claim 10 further comprising:
means for performing a verification operation in response to receiving a verification command from a host device, the verification command specifying the address; the verification operation including reading encrypted record at the address, decrypting the encrypted record using the secure key to retrieve the data and timestamp and reporting successful verification if no errors are detected.

12. The data storage device of claim 10 wherein the timestamp is a POSIX timestamp and the data storage device further comprises:
a power-on hours (POH) to POSIX time table containing an original entry recording a time of manufacture of the device; and
means for rejecting any POSIX time from a host that is earlier than the time of manufacture of the device.

13. A method of operation a data storage device comprising:
recording secure key in a nonvolatile memory location in the data storage device, the location being inaccessible to being read outside of the data storage device; and
performing a write operation in response to receiving a write command from a host device, the write command specifying data and an address, the write operation including:
generating a timestamp for the write operation;
encrypting the data and timestamp using the secure key to produce an encrypted record; and
recording the encrypted record at the address.

14. The method of claim 13 further comprising:
performing a verification operation in response to receiving a verification command from the host device, the verification command specifying an address; the verification operation including reading the encrypted record at the address, decrypting the encrypted record using the secure key to retrieve the data and timestamp and reporting successful verification if no errors are detected.

15. The method of claim 14 wherein the data storage device is a RAID storage system that divides data among a set of sectors on multiple disk drives with some sectors in the set containing only parity data and performing a verification operation further comprising omitting the sectors in the set containing only parity data.

16. The method of claim 13 wherein the timestamp is a POSIX timestamp and generating the timestamp for the write operation further comprises using a table that maps power-on hours to a POSIX time.

17. The method of claim 16 wherein the table contains an entry recording a time of manufacture of the device that is used as an earliest allowed POSIX time.
